(19) United States
(12) Patent Application Publication
(10) Pub. No.: US 2016/0092053 A1
(43) Pub. Date: Mar. 31, 2016

(54) CONTROLLING REMOTE PRESENTATIONS THROUGH A WEARABLE DEVICE

(71) Applicant: Linkedln Corporation, Mountain View, CA (US)

(72) Inventors: Sivakumar Loganathan, Sunnyvale, CA (US); Adrian Ancona Novelo, Sunnyvale, CA (US); Shao-Hua Kao, Santa Clara, CA (US)

(21) Appl. No.: 14/634,144

(22) Filed: Feb. 27, 2015

Related U.S. Application Data
(60) Provisional application No. 62/058,004, filed on Sep. 30, 2014.

(51) Int. Cl. G06F 3/0484; G06F 1/16; H04L 29/06

(52) U.S. Cl. CPC G06F 3/0484; H04L 65/403; G06F 1/163

(57) ABSTRACT

A system and method for controlling and modifying a live presentation with a wearable computing device are disclosed. A server system receives a request to begin a presentation from a wearable computer system. The server system then transmits presentation data to a presentation device for display. While transmitting the presentation data to the presentation device for display, the system receives one or more presentation interactions. The system then transmits each interaction stored in the interaction queue to the presentation device.

### RELATED APPLICATIONS

This application claims the benefit of priority to U.S. Provisional Patent Application Ser. No. 62/058,004, filed Sep. 30, 2014, which is incorporated herein by reference in its entirety.

### TECHNICAL FIELD

The disclosed embodiments relate generally to the field of wireless communication and in particular to uses for wearable devices using wireless communication.

### BACKGROUND

The rise of the computer age has resulted in increased access to services through communication networks. As the costs of electronics and networking services drop, many services that were previously provided in person are now provided remotely over the Internet. For example, entertainment has increasingly shifted to the online space with companies such as Netflix and Amazon streaming television (TV) shows and movies to members at home. Similarly, electronic mail (e-mail) has reduced the need for letters to physically be delivered. Instead, messages are sent over networked systems almost instantly.

Additionally, the reach and speed of the services provided over a network allow near instantaneous communication over great distances. Thus people are able to interact, learn, and work with each other from great distances. In addition, records of these interactions can be stored safely for future use.

### DESCRIPTION OF THE DRAWINGS

Some embodiments are illustrated by way of example and not limitation in the Figures of the accompanying drawings, in which:

FIG. 1 is a network diagram depicting a client-server system that includes various functional components of a server system, in accordance with some embodiments.

FIG. 2A is a block diagram illustrating a control device, in accordance with some embodiments.

FIG. 2B is a block diagram illustrating a client device, in accordance with some embodiments.

FIG. 3 is a block diagram illustrating a server system, in accordance with some embodiments.

FIG. 4A is a user interface diagram illustrating an example of a user interface of a control device for use in controlling a presentation at a different device, according to some embodiments.

FIG. 4B is a diagram illustrating an example of a display at a presentation device, according to some embodiments.

FIG. 5 is a flow diagram illustrating a process for remote control and modification of live presentations from a wearable computing device, in accordance with some embodiments.

FIG. 6 is a block diagram illustrating components of a machine, according to some example embodiments.

Like reference numerals refer to corresponding parts throughout the drawings.

### DETAILED DESCRIPTION

The present disclosure describes methods, systems, and computer program products for controlling remote presentation via a wearable device, in accordance with some embodiments. In the following description, for purposes of explanation, numerous specific details are set forth to provide a thorough understanding of the various aspects of different embodiments. It will be evident, however, to one skilled in the art, that any particular embodiment may be practiced without all of the specific details and/or with variations, permutations, and combinations of the various features and elements described herein.

For a given presentation, a presenter has a control device, which is used to control the presentation, and the presentation is actually presented by a second device (e.g., a presentation device). Traditionally, these two devices have been either the same device (e.g., a laptop) or are part of the same system (e.g., a projector connected to a laptop). However, with modern advances in computing devices this no longer need be the case.

In some example embodiments, a member has access to a wearable computing device, including, but not limited to, a smart watch, a computer device integrated into a pair of glasses, a computer device integrated into a belt or other piece of clothing, a computer device integrated into an arm band, a wristband that includes computing device functionality, and so on. The member uses the wearable device to communicate over a network to a server system. The server system is then connected (e.g., via a communication network) to the presentation device. In some example embodiments, the control device (wearable computing device) is connected to the presentation device via a local wireless network (e.g., via Wi-Fi, etc.) without connecting through a server. In this case, the server functionality is provided by the control device, the presentation device, or a combination thereof.

The server system mediates between the wearable control device (e.g., the control device used by the presenter), the presentation device, and all other devices that are associated with a particular presentation (e.g., the devices of users viewing or attending the presentation). The wearable control device receives input (e.g., commands to control the presentation) from the presenter through an input device (e.g., a touch screen, a microphone, an input button, and so on) and creates interactions based on the input. For example, the presenter swipes on a touch screen of a smart watch to indicate a “next slide” command, and the wearable control device sends the command to the server system over a network.

The server system can receive a variety of different types of commands from a wearable control device. The commands can be grouped into control interactions that control the presentation itself by determining what is currently presented (e.g., what slide is currently shown), changing or altering content (e.g., the presenter erases a specific example and draws another example in its place), displaying audience participation prompts (e.g., an audience quiz), and other interactions that directly control the presented information.

The server system also receives social interactions from the wearable control device or a client device. Social interactions typically are sent from participants (e.g., audience members) and include, but are not limited to: a question, a comment, an answer to a survey or quiz, or a message. Each of these interactions are stored in an interaction queue by the server system and then transmitted to the presentation device in the order they were received. In some example embodiments, there are separate queues for control interactions and social interactions.

In some example embodiments, each device (e.g., the wearable control device, the presentation device, and various client devices associated with audience members) has an associated location (e.g., Global Positioning System (GPS) coordinates). The server system uses the location associated with each device to provide better services to the users of the server system. In some example embodiments, users can search for presentations close to their current location (or to a given location). In response, the server system determines a list of all current presentations and presentations that are scheduled to begin within a certain period of item (e.g., in the next hour) that are within a predefined distance of the user's location.

In some example embodiments, the server system can use the location of the client devices and presentation devices to alert users when a presentation near a particular client device is going live. This can be based on user interests. In some example embodiments, the interests are received from the user. The server system can also automatically add relevant presentations to a user's calendar.

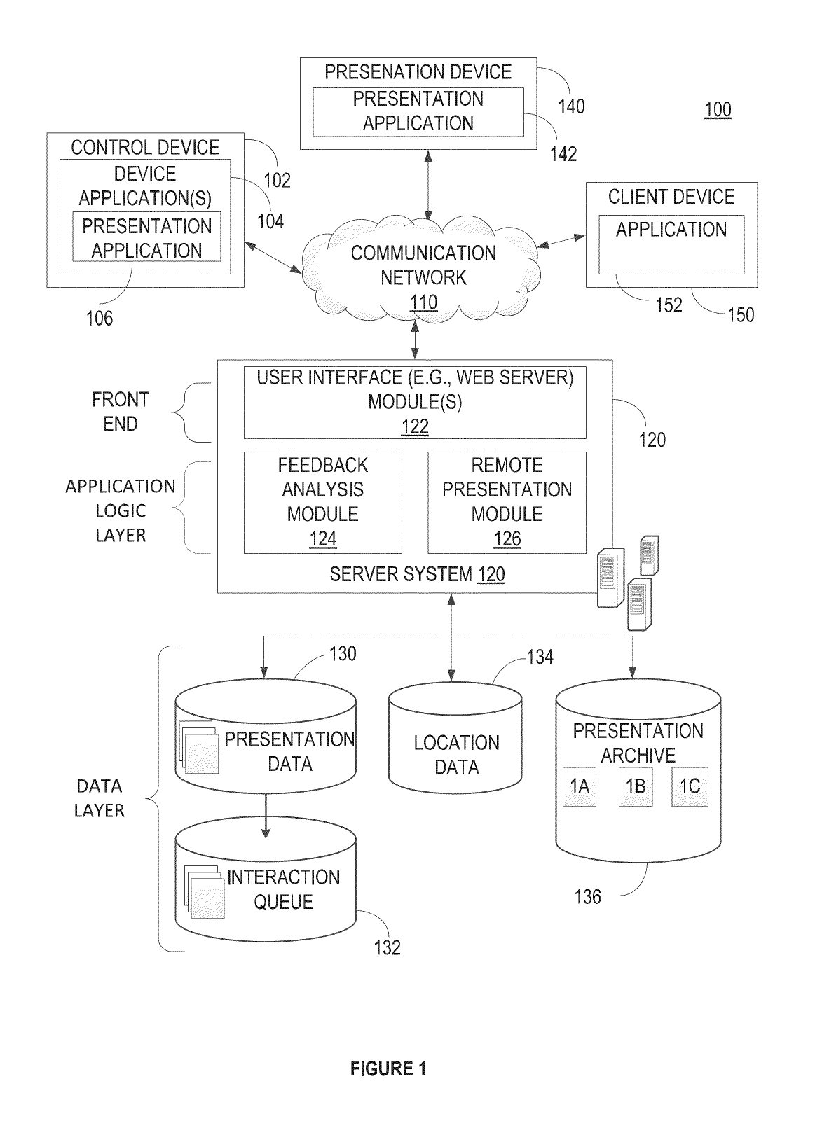

FIG. 1 is a network diagram depicting a client-server system 100 that includes various functional components of a server system 120, in accordance with some embodiments. The client-server system 100 includes one or more wearable control devices 102, a server system 120, one or more presentation devices 140, and one or more client devices 150. One or more communication networks 110 interconnect these components. The communication network 110 may be any of a variety of network types, including local area networks (LANs), wide area networks (WANs), wireless networks, wired networks, the Internet, personal area networks (PANs), or a combination of such networks.

In some embodiments, a wearable control device 102 is an electronic device with one or more processors, such as a smart watch, a computer device integrated into a pair of glasses, a computer device integrated into a belt or other piece of clothing, a computer device integrated into an arm band, a wristband that includes computing device functionality, or any other wearable electronic device capable of communication with a communication network 110. The wearable control device 102 includes one or more device applications 104, which are executed by the wearable control device 102. In some embodiments, the device application(s) 104 includes one or more applications from a set consisting of search applications, communication applications, productivity applications, game applications, word processing applications, or any other useful applications. The device application(s) 104 include a presentation application 106. The wearable control device 102 uses the presentation application 106 to communicate interactions to the server system 120.

The wearable control device 102 transmits interactions (command and social) to the server system 120. Each interaction has an intended target presentation device 140 (e.g., the device that is currently presenting the presentation) and is replayed on the specified presentation device 140 to control a presentation occurring at the presentation device 140. In addition, the presentation application 106 also receives interactions from the server system 120 that have been relayed from one or more client devices 150 (e.g., comments or questions from users viewing the presentation). For example, a wearable control device 102 is being used by a user to control Presentation A at a separate location (e.g., a presentation at a distant university). The wearable control device 102 sends control interactions to the server system 120, which are then replayed on a presentation device 140. The client device 150 sends social interactions that are associated with Presentation A to the server system 120 and the server system 120 transmits the received social interactions to the wearable control device 102.

In some embodiments, as shown in FIG. 1, the server system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid unnecessary detail, various functional modules and engines that are not germane to conveying an understanding of the various embodiments have been omitted from FIG. 1. However, a skilled artisan will readily recognize that various additional functional modules and engines may be used with a server system 120, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the various embodiments are by no means limited to this architecture.

As shown in FIG. 1, the front end consists of a user interface module (e.g., a web server) 122, which receives requests from various client devices 150, and communicates appropriate responses to the requesting client devices 150. For example, the user interface module(s) 122 may receive requests in the form of Hypertext Transport Protocol (HTTP) requests, or other web-based, application programming interface (API) requests. The wearable control device 102 may be executing conventional web browser applications, or applications that have been developed for a specific platform to include any of a wide variety of mobile devices and operating systems.

As shown in FIG. 1, the data layer includes several databases, including databases for storing data for various presentations, including presentation data 130, one or more interaction queues 132, location data 134, and a presentation archive 136.

In some embodiments, presentation data 130 includes all the data needed to display a presentation (e.g., a slideshow, video, or other presentation). A presentation includes pre-set content (e.g., content in a slideshow). For example, slideshow A includes 20 slides, each including specific text for each slide. The slides are transmitted from the server system 120 to a presentation device 140 (or multiple presentation devices) for presentation.

The presentation data 130 also includes an interaction queue 132. The interaction queue 132 includes a list of one or more interactions (e.g., control interactions and social interactions) received from the wearable control device 102 and the one or more client devices 150. Each interaction in the interaction queue 132 represents an interaction of a user with the presentation. This includes control interactions from the presenters, social interactions from one or more users, and any other interaction with a presentation. For example, the presenter can send a control interaction to change the currently displayed slide, edit the presented content, or to pose a question to the audience. An example social interaction includes a question or a comment from a user.

Each interaction is stored in the interaction queue 132 and then transmitted to the presentation device 140, such that the interactions are replayed on the presentation device 140. At least some of the interactions are relayed to the wearable control device 102 that is controlling the presentation.

The server system 120 also stores location data 134 related to each device (e.g., wearable control device 102, presentation device 140, and one or more client devices 150). The location data represents the position of each device, either measured by a location determining device (e.g., a GPS device) or as self-reported by the user of the device. For example, the presentation device 140 has a location that indicates that presentation device 140 is on Stanford University's campus, in a particular room, based on the GPS coordinates of the presentation device 140. The server system 120 uses the location data 134 to determine the location of devices relative to each other. This enables the server system 120 to alert users when a presentation is beginning or scheduled to begin near them.

The presentation archive 136 includes records of past presentations. When a presentation is presented, the specific presentation is recorded. Thus, all information related to the specific presentation event (e.g., 1A, 1B, or 1C) is recorded, including but not limited to all interactions received from control devices 102 and/or client devices 150, the date of the presentation, the time of the presentation, the location of the presentation, the audience of the presentation, and any additional information needed to fully reconstruct a specific presentation event. For example, presentation 1 is presented multiple times to multiple different audiences. Each presentation event varies based on the specific situation of the presentation (e.g., the questions that get asked, the timing of various control actions, and other differences). Thus, each particular presentation event of presentation 1 (e.g., 1A, 1B, and 1C) is stored separately.

In some embodiments, the application logic layer includes various application server modules, including a remote presentation module 126 and a feedback analysis module 124. Individual application server modules are used to implement the functionality associated with various applications, services, and features of the server system 120. For instance, a messaging application, such as an email application, an instant messaging application, or some hybrid or variation of the two, may be implemented with one or more application server modules. Similarly, a search engine enabling members to search for and browse member profiles may be implemented with one or more application server modules.

In addition to the various application server modules, the application logic layer includes the remote presentation module 126. As illustrated in FIG. 1, with some embodiments, the remote presentation module 126 is implemented as a service that operates in conjunction with various application server modules. For instance, any number of individual application server modules can invoke the functionality of the remote presentation module 126 to include an application server module associated with applications for allowing a user with a wearable control device 102 to remotely control a presentation. However, with various alternative embodiments, the remote presentation module 126 may be implemented as its own application server module such that it operates as a stand-alone application.

With some embodiments, the remote presentation module 126 includes or has an associated publicly available API that enables third-party applications to invoke the functionality of the remote presentation module 126.

Generally, the remote presentation module 126 receives a notification that a remote presentation is scheduled to be presented. The notification includes the presentation ID (which identifies a pre-set presentation), a presentation device 140, and a time. The remote presentation module 126 then prepares the specific presentation data for the specific presentation event.

Once the presentation data is ready to be presented, the remote presentation module 126 waits to receive command interactions from the wearable control device 102. Each interaction received from the wearable control device 102 is stored in the interaction queue 132. The remote presentation module 126 then pulls interactions from the interaction queue 132 in the order they were placed in the queue (e.g., in a first in, first out mode (FIFO)) and transmits them to the presentation device 140 to be replayed. In some example embodiments, interactions are also transmitted to the wearable control device 102 (e.g., the device associated with the presenter) such that interactions that originate from one or more client devices 150 are also displayed to the presenter.

In some embodiments, the application logic layer also includes a feedback analysis module 124. A feedback analysis module 124 accesses the presentation archive to retrieve feedback information from previous presentation events. For example, for presentation A, there are three specific presentation events stored in the presentation archive 136 and pre-set content which is stored in the presentation data 130. The feedback analysis module 124 retrieves feedback data for each of the three presentation events stored in the presentation archive 136. Feedback data for particular presentation events includes, but is not limited to, all comments, questions, survey answers, the timing of the control interactions (e.g., how long the presentation stayed on each particular slide) for the particular presentation, and demographic data about the audience for the particular presentation event.

The feedback analysis module 124 then analyzes the feedback data from specific presentation events. Based on this analysis, the feedback analysis module 124 determines specific suggestions to improve future specific presentation events. For example, if the presentation analysis determines that Question B is asked seventy-five percent of the time for slide C, the feedback analysis module 124 suggests that the pre-set presentation be updated to provide the answer to question B as part of slide C for future presentation events.

In some example embodiments the client-server system 100 includes one or more presentation devices 140. A presentation device 140 can be any electronic device capable of displaying or otherwise presenting a presentation including, but not limited to, a personal computer (PC) with a display (e.g., an HD screen), a laptop, a smart phone, a tablet computer, a projector device, or any other electronic device.

The presentation device 140 includes one or more applications. In some example embodiments, the one or more applications include a presentation application 142. The presentation application 142 receives presentation data 130 for the presentation event from the server system 120. The presentation application 142 then receives interactions (e.g., control and social interactions) and updates the displayed presentation based on the received interactions. The presentation device 140 also has an associated location. In some example embodiments, the role of the presentation application 142 is fulfilled by any web browser application that supports JavaScript technology. Thus, the presentation application 142 does not need to be a separate application; instead, it can be a plugin or a web service.

In some example embodiments, the client-server system 100 includes one or more client devices 150. A client device is an electronic device, such as a PC, a laptop, a smartphone, a tablet, a mobile phone, or any other electronic device capable of communication with a communication network 110. The client device 150 includes one or more client applications 152, which are executed by the client device 150. In some embodiments, the client application(s) 152 includes one or more applications from the set consisting of search applications, communication applications, productivity applications, game applications, word processing applications, or any other useful applications.

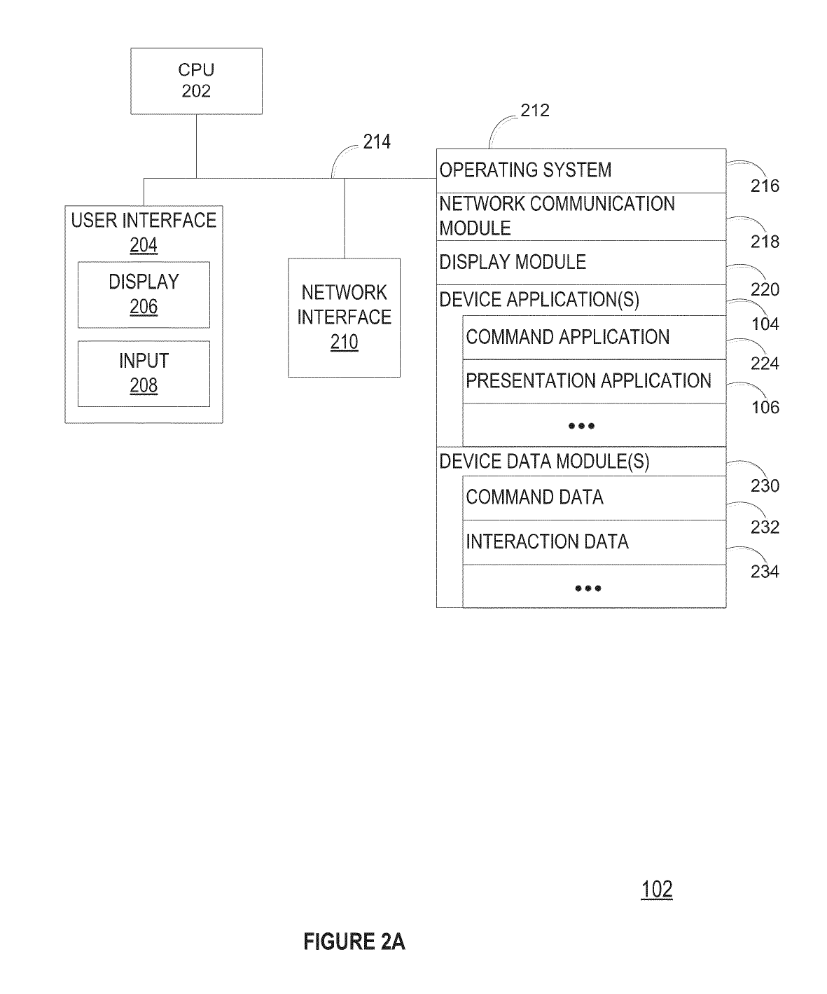

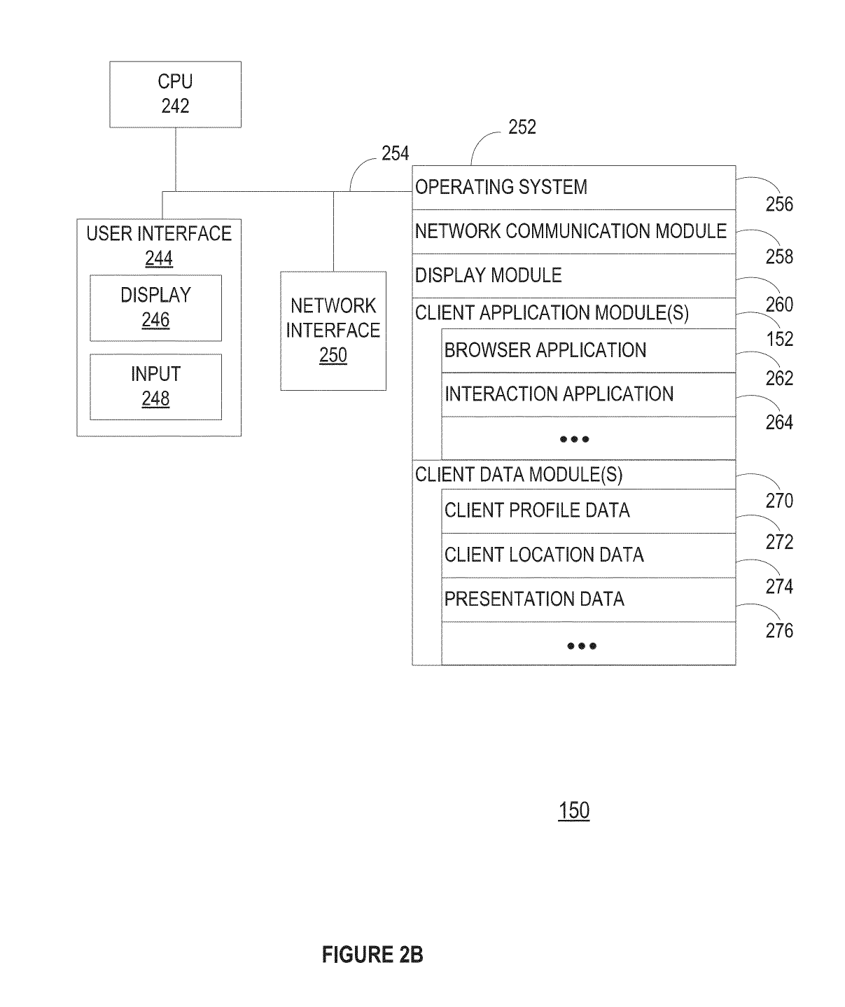

FIG. 2A is a block diagram illustrating a wearable control device 102, in accordance with some embodiments. The wearable control device 102 typically includes one or more processing units (CPUs) 202, one or more network interfaces 210, memory 212, and one or more communication buses 214 for interconnecting these components. The wearable control device 102 includes a user interface 204. The user interface 204 includes a display device 206 and, optionally, an input means such as a touch sensitive display, or other input buttons 208. Furthermore, some control devices 102 use a microphone and voice recognition to supplement or replace the other input mechanisms.

Memory 212 includes high-speed random access memory (RAM), such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 212 may optionally include one or more storage devices remotely located from the CPU(s) 202. Memory 212, or alternately the non- volatile memory device(s) within memory 212, comprises a non-transitory computer readable storage medium.

In some embodiments, memory 212 or the computer readable storage medium of memory 212, stores the following programs, modules, and data structures, or a subset thereof:
an operating system 216 that includes procedures for handling various basic system services and for performing hardware dependent tasks;
a network communication module 218 that is used for connecting the wearable control device 102 to other computers via the one or more communication network interfaces 210 (wired or wireless) and one or more communication networks, such as the Internet, other WANs, LANs, metropolitan area networks (MANs), and so forth;
a display module 220 for enabling the information generated by the operating system 216 and device applications 104 to be presented visually on the display device 206;
one or more device applications 104 for handling various aspects of interacting with the server system 120 (FIG. 1), including but not limited to:
   a command application 224 for sending command interactions to the server system 120 to control the content being displayed at a presentation device (e.g., presentation device 140), wherein control interactions include instructions to begin a specific presentation event, change the content being displayed (e.g., change the current display slide or video), edit the content being displayed, send questions to presentation attendees, and end a presentation; and
   a presentation application 106 for receiving presentation information from the server system 120, including interactions from the interaction queue 132 as seen in FIG. 1;
a device data module 230, for storing data relevant to the wearable control device 102, including but not limited to:
   command data 232 for storing command data interactions that are intended to be sent to the server system 120 to control a particular presentation;
   interaction data 234 for storing one or more interactions (e.g., social interactions from client devices (e.g., device 150 as seen in FIG. 1)) received from the server system (e.g., system 120 in FIG. 1).

FIG. 2B is a block diagram illustrating a client device 150, in accordance with some embodiments. The client device 150 typically includes one or more processing units (CPUs) 242, one or more network interfaces 250, memory 252, and one or more communication buses 254 for interconnecting these components. The client device 150 includes a user interface 244. The user interface 244 includes a display device 246 and optionally includes an input means such as a keyboard, mouse, a touch sensitive display, or other input buttons 248. Furthermore, some client devices 150 use a microphone and voice recognition to supplement or replace the keyboard.

Memory 252 includes high-speed RAM, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 252 may optionally include one or more storage devices remotely located from the CPU(s) 242. Memory 252, or alternately the non-volatile memory device(s) within memory 252, comprises a non-transitory computer readable storage medium.

In some embodiments, memory 252, or the computer readable storage medium of memory 252, stores the following programs, modules, and data structures, or a subset thereof:
an operating system 256 that includes procedures for handling various basic system services and for performing hardware dependent tasks;
a network communication module 258 that is used for connecting the wearable control device 102 to other computers via the one or more communication network interfaces 250 (wired or wireless) and one or more communication networks, such as the Internet, other WANs, LANs, MANs, and so forth;
a display module 260 for enabling the information generated by the operating system 256 and client applications 104 to be presented visually on the display device 246;
one or more client applications 152 for handling various aspects of interacting with the server system (e.g., system 120 of FIG. 1), including but not limited to:
   a browser application 262 for sending and receiving data from the server system 120; and
   an interaction application 264 to send interactions (generally social interactions) to the server system 120 for transmission to a presentation device (e.g., device 140 in FIG. 1);
a client data module 270, for storing data relevant to the client device 150, including but not limited to:
   client profile data 272 for storing data regarding the user associated with the client device 150, including but not limited to demographic information about the user, user interest information, user history information, and any other information regarding the user;
   client location data 274 for storing a location associated with the client device 150 (e.g., GPS coordinates associated with the client device); and
   presentation data 276 for storing presentation data (e.g., data 130 as seen in FIG. 1) and one or more interactions (e.g., interactions from a wearable control device (e.g., device as seen in FIG. 1) and other client devices (e.g., device 150 as seen in FIG. 1)) received from the server system (e.g., system 120 in FIG. 1).

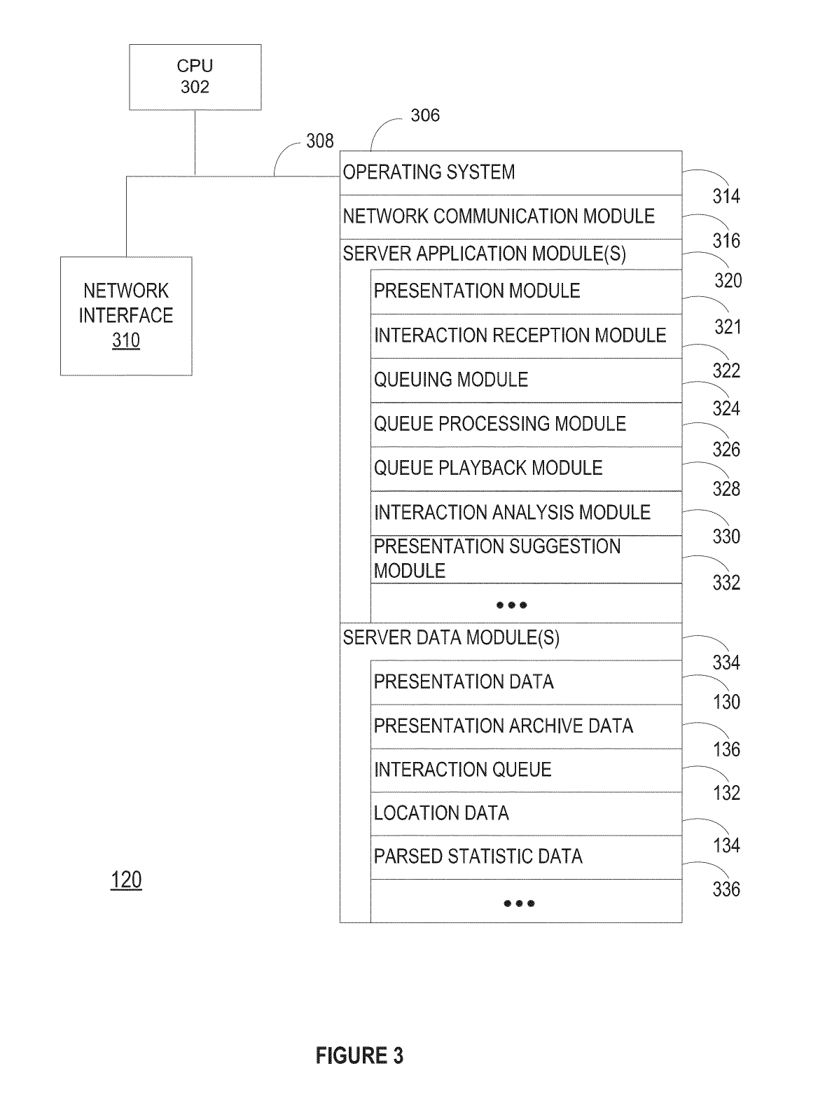

FIG. 3 is a block diagram illustrating a server system 120, in accordance with some embodiments. The server system 120 typically includes one or more processing units (CPUs) 302, one or more network interfaces 310, memory 306, and one or more communication buses 308 for interconnecting these components. Memory 306 includes high-speed RAM, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 306 may optionally include one or more storage devices remotely located from the CPU(s) 302.

Memory 306, or alternately the non-volatile memory device(s) within memory 306, comprises a non-transitory computer readable storage medium. In some embodiments, memory 306, or the computer readable storage medium of memory 306, stores the following programs, modules and data structures, or a subset thereof:
an operating system 314 that includes procedures for handling various basic system services and for performing hardware dependent tasks;
a network communication module 316 that is used for connecting the server system 120 to other computers via the one or more communication network interfaces 310 (wired or wireless) and one or more communication networks, such as the Internet, other WANs, LANS, MANs, and so on;
one or more server application modules 320 for performing the services offered by server system 120, including but not limited to:
   a presentation module 321 for transmitting presentation data 130 and interaction data received from one or more control devices (e.g., device 102 in FIG. 1) and one or more client devices (e.g., device 150 in FIG. 1) and then transmitting the presentation data 130 and the interaction data to the appropriate presentation device (e.g., device 140 in FIG. 1);
   an interaction reception module 322 for receiving control and social interactions from one or more control devices (e.g., device 102 in FIG. 1) and one or more client devices (e.g., device 150 in FIG. 1) and storing those interactions in the interaction queue 132;
   a queuing module 324 for adding interactions into the interaction queue 132;
   a queue processing module 326 for determining which interactions in the queue 132 need to be sent to the presentation device 140, the wearable control device 102, and the one or more client devices 150;
   a queue playback module 328 for transmitting the interactions to the appropriate system based on the determinations of the queue processing module 326;
   an interaction analysis module 330 for analyzing past presentation events to determine patterns that can assist in making more effective presentations; and
   a presentation suggestion module 332 for suggesting improvements to future presentations;
server data modules 334, holding data related to server system 120, including but not limited to:
   presentation data 130 including pre-set presentation data for a plurality of presentations (e.g., specific slides for a slideshow);
   presentation archive data 136 including detailed interaction data from previous presentation events, such as voice recordings of a presenter, content change interactions, social interactions, attendee comments, control interactions, and the timing of the various interactions;
   an interaction queue 132 that stores a plurality of interactions received from one or more control devices (e.g., device 102 in FIG. 1) and one or more client devices (e.g., device 150 in FIG. 1), wherein the interactions are stored in the order they are received and are read out in the same order (e.g., first in, first out);
   location data 134 including a listing of the location of one or more control devices 102, one or more presentation devices 140, and one or more client device 150; and
   parsed statistic data 336 including statistical data regarding interactions received for particular presentation events (e.g., the amount of time spent on each slide, the comments and questions from attendees, the content changes made by the presenters, etc.).

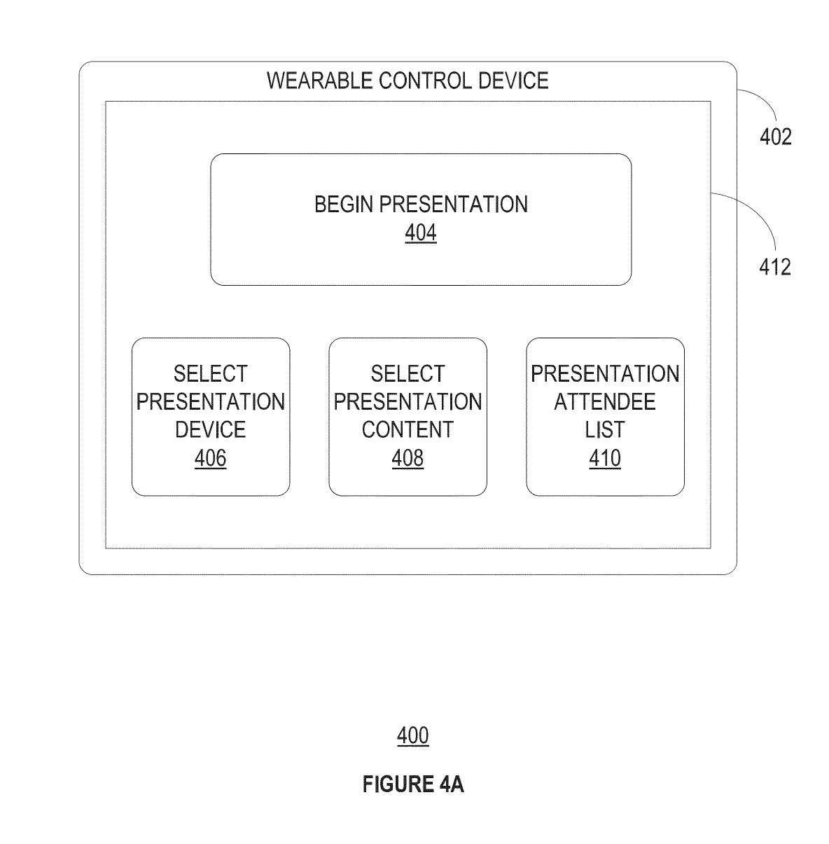

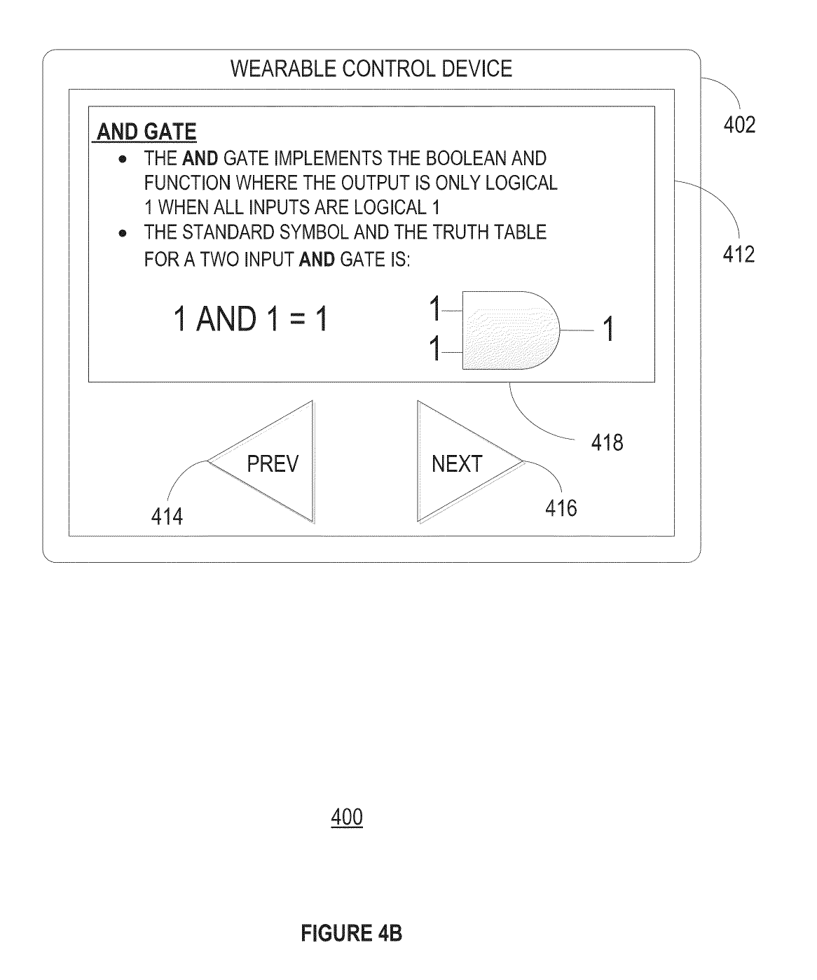

FIG. 4A is a user interface diagram illustrating an example of a user interface 400 of a wearable control device (e.g., device in FIG. 1) for use in controlling a presentation at a different device, according to some embodiments. In the example user interface 400 of FIG. 4, the wearable control device (e.g., device in FIG. 1) is a smart watch 402. The mobile device 402 includes a display screen 412. In some example embodiments, the display screen 412 is a touch screen that can accept finger swipes and gestures as input.

The display screen 412 includes input buttons to control a presentation. The input buttons include a begin presentation button 404, select presentation device button 406, select presentation content 408 button, and a presentation attendee list 410 button. Each button allows a user with the wearable control device to control a presentation at a presentation device (e.g., device 140 in FIG. 1).

The begin presentation button 404 is a button that, when selected, transmits an interaction to the server system (e.g., server system 120 in FIG. 1) that causes the server system to initiation a presentation at a presentation device (e.g., device 140 in FIG. 1).

The select presentation device button 406 allows the user of the wearable control device (e.g., device 102 in FIG. 1) to select the specific presentation device they want to control and send data to. In some example embodiments, the wearable control device displays a list of potential presentation devices to the user in response to selection of the selection presentation device 406. The list is based on the available presentation devices and the permissions of the user.

The select presentation content 408 button allows the user to select a specific presentation to send to the server system (e.g., server system 120 in FIG. 1) or, if the presentation is already stored at the server system (e.g., server system 120 in FIG. 1), to cause the server system (e.g., server system 120 in FIG. 1) to send to the presentation device (e.g., device 140 in FIG. 1). The presentation attendee list button 410 causes a list of all scheduled or current attendees (e.g., people who are watching or will watch the presentation) to be displayed.

FIG. 4B is a diagram illustrating an example of a display 400 at a wearable control device 402, during a presentation, according to some embodiments. In this example, the display of the wearable control device (e.g., device 102 in FIG. 1) shows a replication of the displayed representation 418. The presentation device 402 has a display 412 (e.g., a screen or a projection area) that displays the presentation to attendees. The displayed presentation 418 is updated based on control interactions received from the wearable control device (e.g., device in FIG. 1) or social interactions from a client device (e.g., device 150 in FIG. 1). For example, the member can control the presentation through the next icon 416 (e.g., to go to the next slide) or the previous icon 414 (e.g., to go to the previous slide).

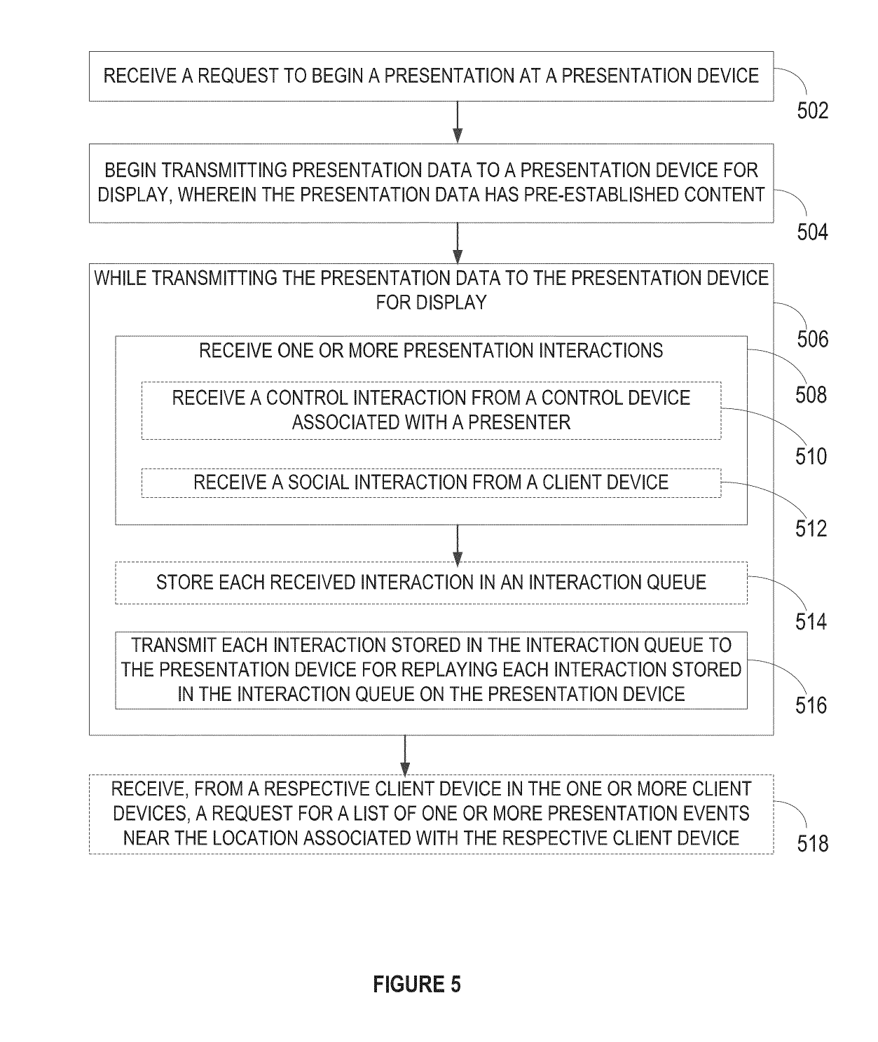

FIG. 5 is a flow diagram illustrating a process for remote control and modification of live presentations in accordance with some embodiments. Each of the operations shown in FIG. 5 may correspond with instructions stored in a computer memory or computer readable storage medium. Optional operations are indicated by dashed lines (e.g., boxes with dashed-line borders). In some embodiments, the method described in FIG. 5 is performed by the server system (e.g., system 120 in FIG. 1).

In some embodiments, the method is performed at a server system including one or more processors and memory storing one or more computer programs for execution by the one or more processors.

The server system receives notification from a wearable control device (e.g., device in FIG. 1) that the user associated with the control device has scheduled a live presentation event. The live presentation event is associated with a specific pre-established presentation (e.g., a standard slideshow that is used for multiple presentation events).

The server system (e.g., server system 120 in FIG. 1) receives (502) a request to begin a presentation at a presentation device, wherein the request identifies a particular presentation device and a particular presentation and is sent from a wearable computing device.

In response to receiving the request to begin, the server system transmits (504) presentation data to a presentation device (e.g., presentation device 140) for display, wherein the presentation data has pre-established content. For example, the server system stores the slides for Presentation J. Then, when a presentation event is scheduled, the server system sends the slide data to the presentation device. The presentation device then causes the presentation data to be presented.

In some example embodiments, while transmitting (506) the presentation data to the presentation device for display, the server system receives (508) one or more presentation interactions. Presentation interactions are messages or data received from control devices or client devices (e.g., device 150 in FIG. 1) that connect to the server system.

Presentation interactions include control interactions that are received (510) from the control device. Control interactions are interactions that control the presentation itself by determining what is currently presented (e.g., what slide is currently shown), changing or altering content (e.g., the presenter erases a specific example and draws another in its place), displaying audience participation prompts (e.g., an audience quiz), and other interactions that directly control the presented information. For example, a presenter uses a control device to control the displayed presentation by changing slides and drawings as appropriate to illustrate a point or answer a question. In other embodiments, control interactions are interactions that result in displaying any kind of presentation meta-information that is not a part of the original presentation slides. One example of this is when a presenter sends a control interaction to display an automatically generated quick response (QR) code and/or direct URL that encodes the event's (or presentation's) URL.

The control interactions received from the first control device include control interactions that change the content presented at the presentation event. For example, the control interaction causes the presentation device to change the display to a different slide or video clip.

In some example embodiments, the control interactions received from the first control device include control interactions that alter the preselected content in the slideshow presentation. For example, the control interaction represents the presenter drawing on the presentation screen to add additional information or to answer questions.

In some example embodiments, receiving presentation interactions includes receiving (512) one or more social interactions from one or more client devices. Examples of social interactions include, but are not limited to: a question, a comment, an answer to a survey or quiz, or a message. Each of these interactions are stored in interaction queue 132 by the server system and then transmitted in order to the presentation device. In some example embodiments, there are separate queues for control interactions and social interactions.

The server system stores (514) each interaction in an interaction queue (e.g., interaction queue 132 of FIG. 1). The interaction queue stores each interaction in the order that it is received. The interactions are then read out based on the order they were stored (e.g., a FIFO system).

In some example embodiments, the server system transmits (516) each interaction stored in the interaction queue to the presentation device for replaying each interaction on the presentation device. For example, the interactions are replayed at the presentation device such that the presentation displayed at the presentation device mirrors the presentation at the control device.

In some example embodiments, the control device is distinct from the presentation device. In some example embodiments, the control device has an associated first location, the presentation device has an associated second location, and the client device has an associated third location. In some example embodiments, the one or more client devices all have different locations (e.g., they are all viewing the presentation remotely). In other embodiments, the one or more client devices all have the same or nearby locations (e.g., all the viewers are attending the presentation at the same location).

In some example embodiments, the server system receives (518) a request for a list of one or more presentation events near the location associated with the respective client device. For example, a user at a university campus requests a list of any presentations on the campus. The server system determines whether a presentation is near based on whether it is within a specific distance. In some example embodiments, the requesting user selects a distance. In other examples, the distance is predetermined by the server system.

In some example embodiments, in response to receiving the request for one or more presentation events, the server system for a respective presentation event in the plurality of presentation events determines whether the respective location associated with the respective presentation event is within a predetermined distance of the third location associated with the client device (e.g., client device 150). For example, if the client device is located in a high school, the server system determines whether the respective presentation event has a location that is also located within the high school.

In some example embodiments, in accordance with a determination that the respective location is within a predetermined distance of the third location, the server system adds the respective presentation event to a list of one or more presentation events within a predetermined distance of the third location.

In some example embodiments, the server system transmits the list of one or more presentations events to the client device. For example, the server system sends a list of four currently running presentations to the requesting client system.

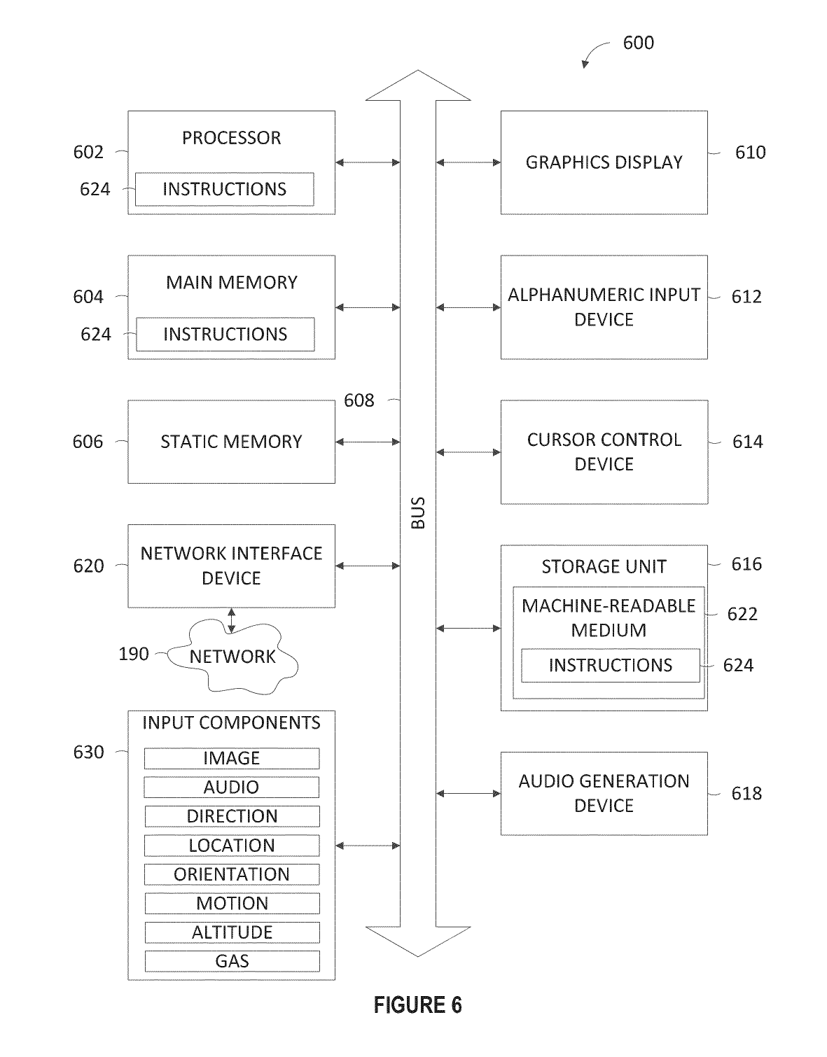

FIG. 6 is a block diagram illustrating components of a machine 600, according to some example embodiments, able to read instructions 624 from a machine-readable medium 622 (e.g., a non-transitory machine-readable medium, a machine-readable storage medium, a computer-readable storage medium, or any suitable combination thereof) and perform any one or more of the methodologies discussed herein, in whole or in part. Specifically, FIG. 6 shows the machine 600 in the example form of a computer system (e.g., a computer) within which the instructions 624 (e.g., software, a program, an application, an applet, an app, or other executable code) for causing the machine 600 to perform any one or more of the methodologies discussed herein may be executed, in whole or in part.

In alternative embodiments, the machine 600 operates as a standalone device or may be connected (e.g., networked) to other machines. In a networked deployment, the machine 600 may operate in the capacity of a server machine or a client machine in a server-client network environment, or as a peer machine in a distributed (e.g., peer-to-peer) network environment. The machine 600 may be a server computer, a client computer, a PC, a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 624, sequentially or otherwise, that specify actions to be taken by that machine. Further, while only a single machine is illustrated, the term “machine” shall also be taken to include any collection of machines that individually or jointly execute the instructions 624 to perform all or part of any one or more of the methodologies discussed herein.

The machine 600 includes a processor 602 (e.g., a CPU, a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The processor 602 may contain microcircuits that are configurable, temporarily or permanently, by some or all of the instructions 624 such that the processor 602 is configurable to perform any one or more of the methodologies described herein, in whole or in part. For example, a set of one or more microcircuits of the processor 602 may be configurable to execute one or more modules (e.g., software modules) described herein.

The machine 600 may further include a graphics display 610 (e.g., a plasma display panel (PDP), a light emitting diode (LED) display, a liquid crystal display (LCD), a projector, a cathode ray tube (CRT), or any other display capable of displaying graphics or video). The machine 600 may also include an alphanumeric input device 612 (e.g., a keyboard or keypad), a cursor control device 614 (e.g., a mouse, a touchpad, a trackball, a joystick, a motion sensor, an eye tracking device, or other pointing instrument), a storage unit 616, an audio generation device 618 (e.g., a sound card, an amplifier, a speaker, a headphone jack, or any suitable combination thereof), and a network interface device 620.

The storage unit 616 includes the machine-readable medium 622 (e.g., a tangible and non-transitory machine-readable storage medium) on which are stored the instructions 624 embodying any one or more of the methodologies or functions described herein. The instructions 624 may also reside, completely or at least partially, within the main memory 604, within the processor 602 (e.g., within the processor's cache memory), or both, before or during execution thereof by the machine 600. Accordingly, the main memory 604 and the processor 602 may be considered machine-readable media (e.g., tangible and non-transitory machine-readable media). The instructions 624 may be transmitted or received over a network 190 via the network interface device 620. For example, the network interface device 620 may communicate the instructions 624 using any one or more transfer protocols (e.g., HTTP).

In some example embodiments, the machine 600 may be a portable computing device, such as a smart phone or tablet computer, and have one or more additional input components 630 (e.g., sensors or gauges). Examples of such input components 630 include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, RAM, read-only memory (ROM), buffer memory, flash memory, and cache memory. While the machine-readable medium 622 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 624 for execution by the machine 600, such that the instructions 624, when executed by one or more processors of the machine 600 (e.g., the processor 602), cause the machine 600 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving, at a server system, a request to begin a presentation at a presentation device, wherein the request identifies a particular presentation device and a particular presentation and is sent from a wearable computing device;
begin transmitting presentation data to the identified presentation device; and
while transmitting presentation data to the identified presentation device:
receiving one or more presentation interactions; and
transmitting the one or more presentation interactions to the identified presentation device in the order that they were received.

2. The method of claim 1, further including, after receiving the one or more presentation interactions, storing each presentation interaction in an interaction queue.

3. The method of claim 2, wherein the server system receives the one or more interactions from one of a group including a control device and one or more client devices.

4. The method of claim 3, wherein the control device is distinct from the presentation device.

5. The method of claim 3, wherein the one or more presentation interactions include a control interaction from a control device associated with a presenter.

6. The method of claim 3, wherein the one or more presentation interactions include one or more social interactions from one or more client devices.

7. The method of claim 3, wherein the control device has an associated first location, the presentation device has an associated second location, and a respective client device of the one or more client devices has an associated third location.

8. The method of claim 7, further including:
receiving, from the respective client device of the one or more client devices, a request for a list of one or more presentation events near the location associated with the respective client device.

9. The method of claim 5, wherein the control interactions received from the first control device include control interactions that change the content currently presented at a presentation event.

10. The method of claim 5, wherein the control interactions received from the first control device include control interactions that alter preselected content in a slideshow presentation.

11. A method comprising:
detecting, at a wearable computing device, a member request to begin a presentation at a presentation device;
transmitting the detected request to a server system; and
receiving one or more presentation control commands, wherein the presentation control commands control the presentation at a presentation device.

12. A system comprising:
one or more processors;
memory; and
one or more programs stored in the memory, the one or more programs comprising instructions for:
receiving, at a server system, a request to begin a presentation at a presentation device, wherein the request identifies a particular presentation device and a particular presentation and is sent from a wearable computing device;
begin transmitting presentation data to the identified presentation device; and
while transmitting presentation data to the identified presentation device:
receiving one or more presentation interactions; and
transmitting the one or more presentation interactions to the identified presentation device in the order that they were received.

13. The system of claim 12, further including instructions for, after receiving the one or more presentation interactions, storing each presentation interaction in an interaction queue.

14. The system of claim 13, wherein the server system receives the one or more interactions from one of a group including a control device and one or more client devices.

15. The system of claim 14, wherein the control device is distinct from the presentation device.

16. The system of claim 14, wherein the one or more presentation interactions include a control interaction from a control device associated with a presenter.

17. A non-transitory computer readable storage medium storing one or more programs for execution by one or more processors, the one or more programs comprising instructions for:
receiving, at a server system, a request to begin a presentation at a presentation device, wherein the request identifies a particular presentation device and a particular presentation and is sent from a wearable computing device;
begin transmitting presentation data to the identified presentation device; and
while transmitting presentation data to the identified presentation device:
receiving one or more presentation interactions; and
transmitting the one or more presentation interactions to the identified presentation device in the order that they were received.

18. The non-transitory computer readable storage medium of claim 17, further including instructions for, after receiving the one or more presentation interactions, storing each presentation interaction in an interaction queue.

19. The non-transitory computer readable storage medium of claim 18, wherein the server system receives the one or more interactions from one of a group including a control device and one or more client devices.

20. The non-transitory computer readable storage medium of claim 19, wherein the control device is distinct from the presentation device.
